(19) United States
(12) Patent Application Publication
(10) Pub. No.: US 2023/0079973 A1
(43) Pub. Date: Mar. 16, 2023

(54) CHARGING STATION FOR CHARGING ELECTRIC VEHICLES

(71) Applicant: ELOADED GMBH, Innsbruck (AT)

(72) Inventor: Frank STEINBACHER, Innsbruck (AT)

(73) Assignee: ELOADED GMBH, Innsbruck (AT)

(21) Appl. No.: 17/801,632

(22) PCT Filed: Feb. 26, 2021
(86) PCT No.: PCT/EP2021/000024

§ 371 Date: Aug. 23, 2022

(30) Foreign Application Priority Data
Mar. 2, 2020 (EP) 20000094.1

(51) Int. Cl. B60L 53/18; H02J 7/00; H02G 11/00; B60L 53/31

(52) U.S. Cl. CPC B60L 53/18; H02J 7/00032; H02G 11/003; B60L 53/31

(57) ABSTRACT

The invention relates to a charging station for charging electric vehicles which comprises an electric charging cable and a spring element. The spring element is secured at one end and is resiliently movable at the other end. The charging station is characterised in particular in that the spring element at least partially supports the electric charging cable.

### TECHNICAL FIELD

The present invention relates to a charging station for electric vehicles.

### PRIOR ART

Charging stations are generally used to charge electric vehicles with electricity. In terms of design, charging stations are often similar to conventional fuel dispensers. That is why charging stations are also referred to as electric charging station or charging post. Such charging posts can be set up in public or non-public spaces. A charging cable with a connector can either be connected to a socket of the charging station or is already attached to the charging station and is used to electrically connect the charging station to an electric vehicle. Some charging posts, such as in US20190047430 A1, comprise a base body and a boom that is rigidly arranged to support the charging cable so that it is kept off the ground.

Various winding and deflecting mechanisms are known for stowing a charging cable, for example from CN110682817A, CN209972210U, CN209921107U, DE202019102323U1, CN209955790U, DE102018211344A1 and DE202011100062U1. Furthermore, a charging cable holder with a base, a spring and a support element attached to one side of the spring is known from utility model CN208544138U. A charging cable is attached to the support element to prevent the charging cable from dragging on the ground and being damaged. The support element can swing out for a charging process with the charging cable and automatically swing the charging cable back to a starting position after the charging process.

### OBJECT

Thus, one object of the invention is to provide a charging station in a compact, safe, and protected design that, in particular, allows the electric vehicle to be driven up close, keeps a charging cable safely off the ground, and allows a user to easily handle the charging cable.

### DISCLOSURE OF THE INVENTION

According to the invention, there is provided a charging station for charging electric vehicles according to claim 1. The charging station according to the invention essentially comprises an electric charging cable and a spring element. The spring element can be fixed at one end and the other end can be resiliently movable. The spring element can support at least partially the electric charging cable.

Preferably, the charging station according to the invention does not comprise a charging post housing. Rather, the charging station according to the invention can have a slim, space-saving design due to the design with electric charging cable and supporting spring. The slim design allows a small distance between the charging station and an electric vehicle to be charged. This can substantially reduce a length of the electric charging cable and thus electrical resistance and heat loss in the electric charging cable. The charging station according to the invention can reduce the need for public space due to its compact design. Furthermore, the charging station according to the invention can be arranged more flexibly in public areas.

The spring element can cause at least a part of the electrical charging cable to be elevated. This allows a high overall service length of the electrical charging cable of, e.g., up to 3 m, to be achieved. Elevation can prevent the electric charging cable from touching a bottom surface or lying in a traffic area. And this is even the case if the electric charging cable is not plugged into an electric vehicle or is not additionally held or rolled up by means of a possible charging cable holder.

Preferably, the spring element supports the electric charging cable from a bottom surface in a substantially vertical or upright manner. Alternatively, the spring element may be attached to a vertical wall and support the electric charging cable upright. Further, the spring element may be attached to a ceiling and support the electrical charging cable vertically downward. When charging with direct current, the electric charging cable generally has a high weight. Coating the electric charging cable can further increase the weight. The spring element can support at least some of this weight; the electric charging cable can be more easily pulled to an electric vehicle for charging. The spring element can be inclined or preloaded in an arc in the direction of the electric vehicle. A restoring force of the spring element can cause the electric charging cable to retract to a rest position after charging the electric vehicle.

Aboveground conventional charging posts housings, typically comprise expensive and sensitive electronic components. The charging station according to the invention can do without such an aboveground charging post housing, so it is generally more protected against vandalism, such as running over, spraying or cutting off the charging cable and spring.

In another embodiment, the spring element may partially surround the electrical charging cable. This allows an even more compact design to be achieved. In particular, slightly more than a total charging cable length above the bottom surface is surrounded by the spring element so that the electrical charging cable does not contact the bottom surface or lie in a traffic area. And this is even the case if the electric charging cable is not plugged into an electric vehicle or is not additionally held or rolled up by means of a possible charging cable holder. In particular, the spring element supports the electric charging cable in a relaxed state such that the electric charging cable does not touch the bottom surface.

According to a preferred embodiment, the spring element may be arranged or attached at one end thereof to a technical unit. The technical unit may comprise at least one of the components: cooling device, controller, DC-DC converter, contactor and relay. In particular, the technical unit is arranged below or parallel to a bottom surface or behind or parallel to a wall area. In particular, the technical unit is concealed. The technical unit preferably replaces the conventional charging station. Due to the concealed arrangement of the technical unit, a visible part of the charging station according to the invention can be designed to be compact and space-saving. The concealed arrangement can protect the expensive components from vandalism. Accidental damage to the components is also generally prevented by the concealed arrangement. A previously required emergency stop switch can be omitted due to the protected design of the charging station according to the invention. The compact design of the charging station according to the invention also prevents litter from being deposited on the charging station, thus reducing clean-up time. Furthermore, the lack of a charging station allows the electric vehicle to drive up close to the charging station according to the invention and saves, for example, parking space.

According to an advantageous embodiment, the charging station according to the invention comprises a direct current charging station, which is in particular connected to a direct current line. A central power source, such as a photovoltaic system, battery, and/or rectifier station, can provide a direct current to one or more direct current charging stations via the direct current line. While conventional charging stations are often connected to alternating current sources and therefore require large components for rectification and cooling, the direct current charging station uses direct current that can be converted to a working direct voltage for charging the electric vehicle, for example, using a compact direct current converter in the technical unit.

Further, the electrical charging cable may comprise a connector and the charging station may comprise a connector mounting for removably holding the connector. The connector comprises, for example, a CCS, Chademo and/or Tesla Supercharger connector. For ergonomic holding of the connector for a user standing in front of the charging station, the connector mounting can be arranged approximately between an average hand height and an elbow height of the user, e.g., at a distance of approximately 664 to approximately 1179 mm from the bottom surface. The connector mounting is preferably arranged on the spring element.

According to another embodiment, the charging station may comprise a status display. For example, the status display is located at the other end of the spring element. Further, the charging station may include wireless communication means. The wireless communication means may be located at the other end of the spring element. Preferably, wireless communication means and status display are integrated in one unit or housing. The status display can be connected to the control in the technical unit. In particular, the status display indicates an availability, a fault, an ongoing charging process and/or a completed charging process. The status display may include one or more visual and/or audible display means, such as lamps, displays, and speakers. The wireless communication means may be connected to the controller in the technical unit. The wireless communication means includes, for example, WLAN, NFC, or Bluetooth, and can wirelessly exchange information about the status of the charging station, details of a charging process, and the like with another wirelessly communicating terminal, such as the user's smartphone. By consistently separating charging station components that are required aboveground, such as the status display and/or wireless communication means, and those that are not required aboveground, such as the components of the concealed technical unit, the charging station according to the invention can be designed in a compact and protected form.

In another preferred embodiment, the spring element comprises a coil spring. The coil spring allows, among other things, to partially surround the electric charging cable. This can protect the electric charging cable from damage. Furthermore, the coil spring can vertically elevate the surrounding charging cable part.

In a further embodiment, the spring element may have two different pitches. Furthermore, the spring element or its pitches, its length and/or its spring stiffness can be individually designed for a weight or length of the electric charging cable. The different pitches allow different resilient deformations over the length of the spring element.

The spring element is surrounded in particular by a flexible protective sleeve. The flexible protective sleeve can protect the spring element from environmental influences, dirt and damage.

Advantageous further embodiments of the invention are given in the dependent claims and described in the description.

### BRIEF DESCRIPTION OF THE DRAWINGS

Examples of embodiments of the invention are explained in more detail with reference to the drawings and the following description. The following shows:

FIG. 1, an embodiment of a charging station according to the invention and

FIG. 2, another example of a charging station according to the invention.

### EMBODIMENTS OF THE INVENTION

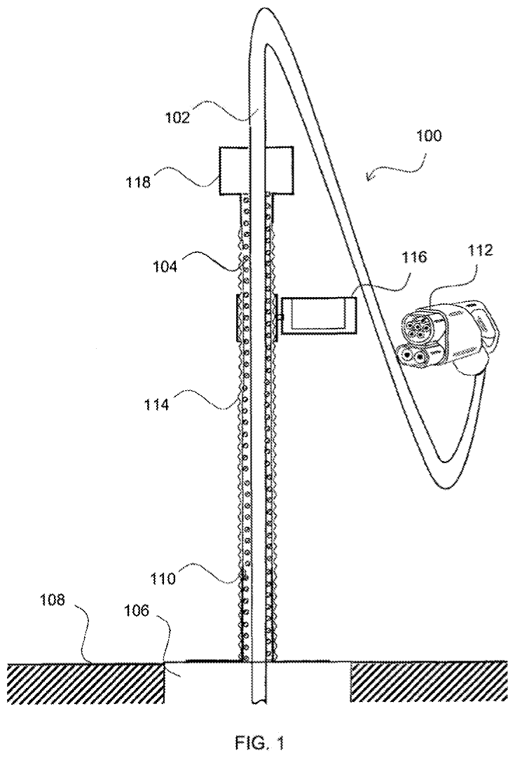

FIG. 1 shows a charging station 100 for charging an electric vehicle. The charging station 100 includes an electrical charging cable 102, a helical compression spring 104, and a technical unit 106. The technical unit 106 is recessed into or disposed below a bottom surface 108. The helical compression spring 104 is attached by means of a flange 110 to a side surface of the technical unit 106 that is parallel to or flush with the bottom surface 108. As a result, the helical compression spring 104 protrudes perpendicularly or vertically from the bottom surface 108. The flange 110 is attached to the side surface with several fastening screws. The electrical charging cable 102 is routed through the flange 110 and electrically connected inside the technical unit 106. The helical compression spring 104 is about 1100 to 1500 mm long and has a diameter of about 65 mm; the charging cable 102 is disposed in the inner coil diameter of the helical compression spring 104. The charging cable 102 has a length of 2200 to 3000 mm, so it is guided essentially halfway along its length in the helical compression spring 104. At another end of the helical compression spring 104, the charging cable 102 is exposed. The helical compression spring 104 is dimensioned with respect to the charging cable 102, particularly with respect to pitch, length, and spring stiffness, such that the charging cable 102 is vertically supported in a rest position of the helical compression spring 104 and does not rest on the floor surface 108.

The helical compression spring 104 is surrounded by a flexible protective sleeve 114 that protects the helical compression spring 104 from environmental influences, contamination, and damage.

A direct current charging connector 112 is disposed at a free end of the charging cable 102. In a rest position of the helical compression spring 104, the direct current charging connector 112 is removably retained by a mounting bracket 116. The mounting bracket 116 is attached to the protective sleeve 114 or the helical compression spring 104 at a distance of about 664 to about 1179 mm from the bottom surface 108.

For a charging process, a user grabs the direct current charging connector 112, removes it from the mounting bracket 116, pulls on the direct current charging connector 112 in the direction of the electric vehicle, then stretches a free part of the charging cable 102, pulls further and resiliently deforms the helical compression spring 104, wherein the other end of the helical compression spring 104 together with the charging cable 102 arranged therein inclines further in the direction of the electric vehicle and thus bridges a distance between the charging station 100 and the electric vehicle. After the charging process, the user can easily guide the direct current charging plug 112 back towards the charging station 100, wherein the tensioned helical compression spring 104 supports the charging cable 102 and assists the user by means of a restoring force.

The charging station 100 further includes a cylindrical status light 118 having a diameter of 150 mm disposed at the other end of the helical compression spring 104 and including one or more visual indication means, such as omnidirectional lights and displays, to indicate an availability, a fault, an ongoing charging process and/or a completed charging process. Further, the charging station 100 comprises a WLAN-unit integrated in the status light 118 and adapted to wirelessly transmit information about the status of the charging station 100, details of a charging process and the like to a smartphone of the user or to the electric vehicle.

The elevation of the charging cable 102 facilitates the operation of the cable, as the helical compression spring 104 takes some of the weight of the cable. Thus, easier handling for guiding the charging cable 102 is achieved. Due to the compact dimensions of the helical compression spring 104 and status light 118, the charging station 100 takes up little space in a public area and the charging cable 102 can be routed closer to the electric vehicle. Furthermore, the compact dimensions allow free positioning of the charging cable 102 in public spaces. By separating the underground technical unit 106 and the aboveground components, such as the charging cable 102 and helical compression spring 104, no live circuitry can be exposed if the spring is run over or torn out. This increases operational safety; an emergency stop switch is no longer required. The charging station 100 also has a higher level of protection against vandalism than conventional charging stations, since essentially only the charging cable 102 and the helical compression spring 104 can be disconnected, making theft unattractive due to the short length of the cable. Spraying or painting is uninteresting due to the small surface area. Also, trash cannot be easily placed on the charging station 100. The small space required of the charging station 100 also makes it easy to retrofit in public spaces, parking garages and underground garages.

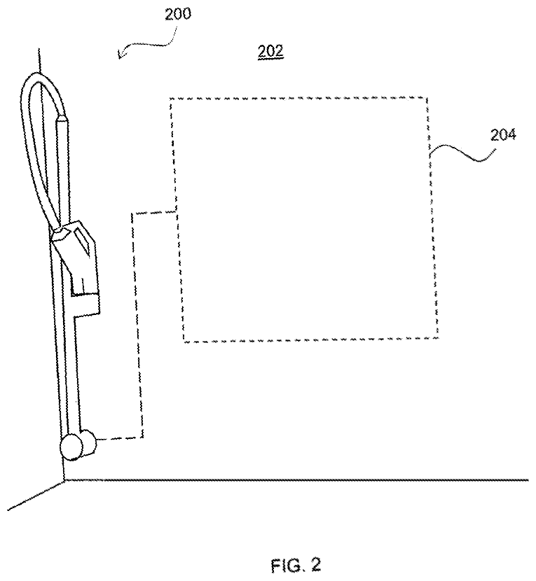

FIG. 2 shows a charging station 200 attached to a parking garage wall 202. A technical unit 204, similar to the technical unit 106 in FIG. 1, is arranged behind the parking garage wall 202, i.e. concealed.

### LIST OF REFERENCE NUMERALS

100 Charging station
102 Electrical cable
104 Helical compression spring
106 Technical unit
108 Bottom surface
110 Flange
112 Direct current charging connector
114 Protective sleeve
116 Mounting bracket
118 Status light
200 Charging station
202 Parking garage wall
204 Technical unit

1-15. (canceled)

16. Charging station for charging electric vehicles, comprising
an electric charging cable and
a spring element which is fixed at one end and which is resiliently movable at another end,
wherein
the spring element at least partially supports the electric charging cable.

17. Charging station according to claim 16,
wherein
the spring element partially surrounds the electrical charging cable.

18. Charging station according to claim 16,
wherein
the spring member supports the electrical charging cable in a relaxed state such that the electrical charging cable does not contact a bottom surface.

19. Charging station according to claim 16,
wherein
the spring element is arranged at its one end on a technical unit.

20. Charging station according to claim 19,
wherein
the technical unit comprises at least one of the following components: cooling device, controller, DC-DC converter, contactor and relay.

21. Charging station according to claim 19,
wherein
the technical unit is fixed under a bottom surface or behind a wall surface.

22. Charging station according to claim 16,
wherein
the charging station comprises a direct current charging station, which is in particular connected to a direct current line.

23. Charging station according to claim 16,
wherein
the electrical charging cable comprises a connector, and
the charging station comprises a connector mounting for removably holding the connector.

24. Charging station according to claim 16,
wherein
the charging station comprises a status display.

25. Charging station according to claim 16,
wherein
the status display is arranged at the other end of the spring element.

26. Charging station according to claim 16,
wherein
the charging station comprises a wireless communication means.

27. Charging station according to claim 26,
wherein
the wireless communication means is arranged at the other end of the spring element.

28. Charging station according to claim 16,
wherein
the spring element comprises a coil spring.

29. Charging station according to claim 16,
wherein
the spring element has at least two different pitches.

30. Charging station according to claim 16,
wherein
the spring element is surrounded by a flexible protective sleeve.
